(19) United States
(12) Patent Application Publication
(10) Pub. No.: US 2007/0182321 A1
(43) Pub. Date: Aug. 9, 2007

(54) Organic electroluminescence device and producing method therefor

(75) Inventors: Masaru Kinoshita, Kanagawa (JP); Manabu Tobise, Kanagawa (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/702,634

(22) Filed: Feb. 6, 2007

(30) Foreign Application Priority Data
Feb. 9, 2006 (JP) 2006-032960

(51) Int. Cl. H01J 1/62

(52) U.S. Cl. 313/506

(57) ABSTRACT

An organic electroluminescence device including an organic layer including at least a light-emitting layer between a pair of electrodes, wherein a light-emitting plane of the organic electroluminescence device comprises at least two light-emitting areas having light emission colors that are different from each other, of which one is a first light-emitting area emitting a light of a first color and another is a second light-emitting area emitting a light of a second color, wherein the second light-emitting area has a composition that is the same as that of the first light-emitting area and is denatured to the second light-emitting area by heating. An organic electroluminescence device and a producing method thereof having excellent production feasibility are provided.

### CROSS-REFERENCE TO RELATED APPLICATION

This application claims priority under 35 USC 119 from Japanese Patent Application No.2006-32960, the disclosure of which is incorporated by reference herein.

### BACKGROUND OF THE INVENTION

1. Field of the Present Invention

The present invention relates to an organic electroluminescence device (which is referred to hereinafter as an “organic EL device” in some cases) which can be effectively applied to a surface light source for full color display, backlight, illumination light sources and the like, or to a light source array for printers, and the like.

2. Description of the Related Art

An organic EL device is composed of a light-emitting layer or a plurality of organic layers containing a light-emitting layer, and a pair of electrodes sandwiching the organic layers. The organic EL device is a device for obtaining luminescence by utilizing at least either one of luminescence from excitons each of which is obtained by recombining an electron injected from a cathode with a positive hole injected from an anode to produce the exciton, or luminescence from excitons of other molecules produced by energy transmission from the above-described excitons.

Heretofore, an organic EL device has been developed by using a laminate structure from integrated layers in which each layer is functionally differentiated, whereby brightness and device efficiency have been remarkably improved. For example, it is described in “Science”, vol. 267, No. 3, page 1332 (1995) that a two-layer laminated type device obtained by laminating a positive hole-transport layer and a light-emitting layer also functioning as an electron-transport layer; a three-layer laminated type device obtained by laminating a positive hole-transport layer, a light-emitting layer, and an electron-transport layer; and a four-layer laminated type device obtained by laminating a positive hole-transport layer, a light-emitting layer, a positive hole-blocking layer, and an electron-transport layer have been frequently used.

However, various problems still remain in the commercial utilization of the organic EL device. One of the problems is a deterioration in quality owing to an electric current leak causing by foreign substances.

For example JP-A-2005-5149 proposes a process of heating an entire device after preparation thereof to melt or soften the organic material, and to enclose foreign substances such as dust on a surface of the device or in the interior of the device, thereby preventing an electric leak in the device.

It has also been attempted to apply an organic EL device to mono-color and multi-color area color panels. For the multi-color panel, there are known, for example, a 3-color independent pixel system, a color filter system and a color modulation system. The 3-color independent pixel system utilizes, as pixels, devices exhibiting light emissions respectively corresponding to three colors, and requires arranging pixels of the 3 colors on a substrate at a fine pitch of about several hundred micrometers, but is capable of providing a sharp image of high luminance, because emitted light is used directly and has high utilization efficiency. However, it is extremely difficult to arrange the fine pixels of the three colors precisely on the substrate, and the difficulty further increases in the case of a large image size. The color filter system utilizes separation of white emitted light into three colors by color filters of three colors. Therefore, since only by about ⅓ of the emitted light is utilized, utilization efficiency is low, and thus, luminance is lowered. In the color conversion system, blue light is emitted over the entire area by a main light-emitting layer and is converted into three colors by a sub light-emitting layer laminated thereon. This system also involves lowered utilization efficiency and difficulty in the production in preparing a complex multi-layered laminate structure.

### SUMMARY OF THE INVENTION

The present invention has been made in view of the above circumstances and provides an organic electroluminescence device comprising an organic layer including at least a light-emitting layer between a pair of electrodes, wherein a light-emitting plane of the organic electroluminescence device comprises at least two light-emitting areas having light emission colors that are different from each other, of which one is a first light-emitting area emitting a light of a first color and another is a second light-emitting area emitting a light of a second color, wherein the second light-emitting area has a composition that is the same as that of the first light-emitting area and is denatured to the second light-emitting area by heating.

A second aspect of the present invention is to provide a producing method for an organic electroluminescence device comprising at least two light-emitting areas in a light-emitting plane having different wavelengths of light emission, wherein the producing method comprises forming a laminate member, in which a first electrode, an organic layer including at least a light-emitting layer, and a second electrode are laminated on a subtrate, and then carrying out denaturing by locally heating at a temperature higher than a glass transition temperature of a host material of the light-emitting layer, to thereby form one of the light-emitting areas.

### DETAILED DESCRIPTION OF THE INVENTION

An object of the present invention is to provide a multicolor organic electroluminescence device and a producing method of the organic electroluminescence device having excellent production feasibility.

The organic EL device of the present invention is an organic electroluminescence device including an organic layer, containing at least a light-emitting layer, between a pair of electrodes, wherein a light-emitting plane of the organic electroluminescence device includes at least two light-emitting areas of having light emission colors that are different from each other, of which one is a first light-emitting area emitting light of a first color and another is a second light-emitting area emitting light of a second color, wherein the second light-emitting area has a composition that is the same as that of the first light-emitting area and is denatured to the second light-emitting area by heating.

Preferably, the aforementioned light-emitting layer includes at least two laminated layers, wherein a first light-emitting layer is a light-emitting layer denatured by the heating, and a second light-emitting layer is a light-emitting layer not denatured by the heating.

Preferably, a host material in the first light-emitting layer has a glass transition temperature lower than the temperature of the heating, and a host material in the second light-emitting layer has a glass transition temperature higher than the temperature of the heating.

According to the present invention, pixels of plural different colors can be formed on a plane by heating. Thus, a multi-color organic EL device can be prepared extremely easily in comparison with the conventional processes of forming fine patterns by evaporation or by coating processes in different areas.

Preferably, the first light-emitting layer and the second light-emitting layer contain dopants, and an organic layer substantially free of dopant is positioned between the first light-emitting layer and the second light-emitting layer. In this manner, the first light-emitting layer and the second light-emitting layer can emit lights without mixing of colors.

In the present invention, a third light-emitting layer may also be provided in a similar manner.

Preferably, at least a light reflecting plane is provided at the side of one of the electrodes, wherein the first light-emitting layer and the second light-emitting layer emit light of mutually different wavelengths, and the light-emitting layer having the shorter wavelength is positioned between the light-emitting layer having the longer wavelength and the light reflecting plane.

The organic EL device of the present invention is produced by a producing method of forming a laminate member, in which a first electrode, an organic layer including at least a light-emitting layer, and a second electrode are laminated on a substrate, and then carrying out denaturing by locally heating at a temperature higher than the glass transition temperature of a host material of the light-emitting layer, to thereby form one of the light-emitting areas.

Preferably employed is a producing method in which the first light-emitting layer is a layer containing a host material having a glass transition temperature lower than the denaturing temperature, the second light-emitting layer is a layer containing a host material having a glass transition temperature higher than the denaturing temperature, and only the first light-emitting layer is denatured by the heating.

Preferably, a thermal head or laser beam irradiation may be utilized for the heating.

The producing method of the present invention makes it possible to easily produce a highly precise pattern by, for example, reducing the size of the thermal head or concentrating the laser beam.

In the following, the organic electroluminescence device of the present invention will be described in detail.

(Constitution)

The organic electroluminescence device according to the present invention has at least one organic compound layer including a light-emitting layer in between a pair of electrodes (anode and cathode), and further preferably has a positive hole-injection layer between the anode and the light-emitting layer as well as an electron-transport layer between the cathode and the light-emitting layer.

In view of the nature of an electroluminescence device, it is preferred that at least either electrode of the pair of electrodes is transparent.

As a lamination pattern of the organic compound layers according to the present invention, it is preferred that the layers are laminated in the order of a positive hole-injection layer, a light-emitting layer, and electron-transport layer from the anode side. Moreover, a positive hole-transport layer between the positive hole-injection layer and the light-emitting layer and/or an electron transporting intermediate layer between the light-emitting layer and the electron-transport layer may be provided. In addition, a positive hole transporting intermediate layer may be provided in between the light-emitting layer and the positive hole-transport layer, and similarly, an electron injection layer may be provided in between the cathode and the electron-transport layer.

The preferred modes of the organic compound layer in the organic electroluminescence device of the present invention are as follows. (1) An embodiment having a positive hole-injection layer, a positive hole-transport layer (the positive hole-injection layer may also have the role of the positive hole-transport layer), a positive hole transporting intermediate layer, a light-emitting layer, an electron-transport layer, and an electron injection layer (the electron-transport layer may also have the role of the electron injection layer) in this order from the anode side; (2) an embodiment having a positive hole-injection layer, a positive hole-transport layer (the positive hole-injection layer may also have the role of the positive hole-transport layer), a light-emitting layer, an electron transporting immediate layer, an electron-transport layer, and an electron injection layer (the electron-transport layer may also have the role of the electron injection layer); and (3) an embodiment having a positive hole-injection layer, a positive hole-transport layer (the positive hole-injection layer may also have the role of the positive hole-transport layer), a positive hole transporting intermediate layer, a light-emitting layer, an electron transporting intermediate layer, an electron-transport layer, and an electron injection layer (the electron-transport layer may also have the role of the electron injection layer).

The above-described positive hole transporting intermediate layer preferably has at least either a function for accelerating the injection of positive holes into the light-emitting layer, or a function for blocking electrons.

Furthermore, the above-described electron transporting intermediate preferably layer has at least either a function for accelerating the injection of electrons into the light-emitting layer, or a function for blocking positive holes.

Moreover, at least either of the above-described positive hole transporting intermediate layer and the electron transporting intermediate layer preferably has a function for blocking excitons produced in the light-emitting layer.

In order to realize effectively the functions for accelerating the injection of positive hole, or the injection of electrons, and the functions for blocking positive holes, electrons, or excitons, it is preferred that the positive hole transporting intermediate layer and the electron transporting intermediate layer are adjacent to the light-emitting layer.

The respective layers mentioned above may be separated into a plurality of secondary layers.

Next, the components constituting the electroluminescence device of the present invention will be described in detail.

An organic compound layer according to the present invention will be described.

The organic electroluminescence device of the present invention has at least one organic compound layer including a light-emitting layer. Examples of the organic compound layers other than the light-emitting layer include, as mentioned above, respective layers of a positive hole-injection layer, a positive hole-transport layer, a positive hole transporting intermediate layer, a light-emitting layer, an electron transporting intermediate layer, an electron-transport layer, an electron injection layer and the like.

(Electron Injection Layer and Electron-Transport Layer)

The electron injection layer and the electron-transport layer are layers having any of functions for injecting electrons from the cathode, transporting electrons, and becoming a barrier to positive holes which could be injected from the anode.

The electron injection layer and/or the electron-transport layer of the present invention preferably contain an electron-donating dopant in view of improvements in decreasing in driving voltage and increasing in driving durability.

As a material applied for the electron-donating dopant with respect to the electron injection layer or the electron-transport layer, any material may be used as long as it has an electron-donating property and a property for reducing an organic compound, and alkaline metals such as Li, alkaline earth metals such as Mg, and transition metals including rare-earth metals are preferably used.

Particularly, metals having a work function of 4.2 V or less are preferably applied, and specific examples thereof include Li, Na, K, Be, Mg, Ca, Sr, Ba, Y. Cs, La, Sm, Gd, and Yb. Specific examples of the reducing organic compound are, for example, a nitrogen-containing compound, a sulfur-containing compound and a phosphor-containing compound and the like. Other specific examples of the reducing organic compound include materials described in patent documents such as JP-A Nos. 6-212153, 2000-196140, 2003-68468, 2003-229278, 2004-342614 and the like.

These electron-donating dopants may be used alone or in a combination of two or more of them.

An applied amount of the electron-donating dopants differs dependent on the types of the materials, but it is preferably 0.1% by mass to 99% by mass with respect to an electron-transport layer material, more preferably 1.0% by mass to 80% by mass, and particularly preferably 2.0% by mass to 70% by mass. When the amount applied is less than 0.1% by mass, the efficiency of the present invention is insufficient so that it is not desirable, and when it exceeds 99% by mass, the electron transportation ability is deteriorated so that it is not preferred.

Specific examples of the materials applied for the electron injection layer and the electron-transport layer include pyridine, pyrimidine, triazine, imidazole, triazole, oxazole, oxadiazole, fluorenone, anthraquinodimethane, anthrone, diphenylquinone, thiopyrandioxide, carbodiimide, imide, fluorenylidenemethane, distyrylpyradine, fluorine-substituted aromatic compounds, naphthalene, heterocyclic tetracarboxylic anhydrides such as perylene, phthalocyanine, and the derivatives thereof (which may form condensed rings with the other rings); and metal complexes represented by metal complexes of 8-quinolinol derivatives, metal phthalocyanine, and metal complexes containing benzoxazole, or benzothiazole as the ligand.

Although a thickness of the electron injection layer and the electron-transport layer is not particularly limited, it is preferred that the thickness is in 1 nm to 5 μm, it is more preferably 5 nm to 1 μm, and it is particularly preferably 10 nm to 500 nm in view of decrease in driving voltage, improvements in luminescent efficiency, and improvements in durability.

The electron injection layer and the electron-transport layer may have either a monolayered structure comprising one or two or more of the above-mentioned materials, or a multilayer structure composed of plural layers of a homogeneous composition or a heterogeneous composition.

When the carrier transportation layer adjacent to the light-emitting layer is an electron-transport layer, it is preferred that the Ea (ETL) of the electron-transport layer is higher than the Ea (D) of the dopants contained in the light-emitting layer in view of driving durability.

For the Ea (ETL), a value measured in accordance with the same manner as the measuring method of Ea, which will be mentioned later, is used.

Furthermore, the carrier mobility in the electron-transport layer is usually from 10⁻⁷ cm².V⁻¹.s⁻¹ to 10⁻¹ cm².V⁻¹.s⁻¹, and in this range, from 10⁻⁵ cm².V⁻¹.s⁻¹ to 10⁻¹ cm².V⁻¹.s⁻¹ is preferable, from 10⁻⁴ cm².V⁻¹.s⁻¹ to 10⁻¹ cm².V⁻¹.s⁻¹ is more preferable, and from 10⁻³ cm².V⁻¹.s⁻¹ to 10⁻¹ cm².V⁻¹.s⁻¹ is particularly preferred, in view of luminescent efficiency.

Moreover, it is preferred that the carrier mobility in the electron-transport layer is higher than that of the light-emitting layer in view of driving durability. The carrier mobility is measured in accordance with the same method as that of the positive hole-transport layer.

As to the carrier mobility of the luminescent device of the present invention, it is preferred that the carrier mobility in the positive hole-transport layer, the electron-transport layer, and the light-emitting layer has the relationship of (electron-transport layer >positive hole-transport layer) >light-emitting layer in view of driving durability.

As the host material contained in the buffer layer, the below-mentioned positive hole transporting host or electron transporting host may be preferably used.

(Light-Emitting Layer)

The light-emitting layer is a layer having a function for receiving positive holes from the anode, the positive hole-injection layer, the positive hole-transport layer or the positive hole transporting buffer layer, and receiving electrons from the cathode, the electron injection layer, the electron-transport layer, or the electron transporting buffer layer, and for providing a field for recombination of the positive holes with the electrons to emit light.

The present invention is characterized in that at least one light-emitting layer is denatured by heating to thereby exhibit a different light emission. Preferably, the host material of such a light-emitting layer has a glass transition temperature within a temperature range lower than the heating temperature for denaturing. Within the plane of such a light-emitting layer, an unheated pixel area of a first light emission color, and a heated pixel area of a second light emission color different from the first light emission color are formed by the denaturing by heating. Thus, within the same light-emitting layer, color pixels of at least two colors are formed according to a heating pattern. The light emitting material of the light-emitting layer of the present invention includes a host material and a dopant, in which the denaturing may be executed in either one of the host material or the dopant, but preferably in the host material.

The light-emitting layer of the present invention may further include a second light-emitting layer. In the second light-emitting layer, a host material contained therein preferably has a glass transition temperature in a temperature range higher than the heating temperature for denaturing, and the light emission characteristics are preferably not changed by the heating process.

The luminescent dopant and the plural host compounds contained in the light-emitting layer of the present invention may be either a combination of a fluorescence luminescent dopant in which the luminescence (fluorescence) from a singlet exciton is obtained and the plurality of host compounds, or a combination of a phosphorescence luminescent dopant in which the luminescence (phosphorescence) from triplet exciton is obtained and the plurality of host compounds; among these, a combination of the phosphorescence luminescent dopant and the plurality of host compounds is preferable in view of luminescent efficiency.

The light-emitting layer of the present invention may contain two or more types of luminescent dopants for improving color purity and expanding the luminescent wavelength region.

<<Luminescent Dopant>>

Any of phosphorescent emission materials, fluorescent emission materials and the like may be used as the luminescent dopant in the present invention.

It is preferred that the luminescent dopant in the present invention is one satisfying a relationship between the above-described host compound and the luminescent dopant of 1.2 eV>ΔIp>0.2 eV and/or 1.2 eV>ΔEa>0.2 eV in view of driving durability.

<<Phosphorescence Luminescent Dopant>>

Examples of the above-described phosphorescence luminescent dopant generally include complexes containing transition metal atoms or lantanoid atoms.

For instance, although the transition metal atoms are not limited, they are preferably ruthenium, rhodium, palladium, tungsten, rhenium, osmium, iridium, or platinum; more preferably rhenium, iridium, and platinum, or even more preferably iridium, or platinum.

Examples of the lantanoid atoms include lanthanum, cerium, praseodymium, neodymium, samarium, europium, gadolinium, terbium, dysprosium, holmium, erbium, thulium, ytterbium, and lutetium, and among these lantanoid atoms, neodymium, europium, and gadolinium are preferred.

Examples of ligands in the complex include the ligands described, for example, in “Comprehensive Coordination Chemistry” authored by G Wilkinson et al., published by Pergamon Press Company in 1987; “Photochemistry and Photophysics of Coordination compounds” authored by H. Yersin, published by Springer-Verlag Company in 1987; and “YUHKI KINZOKU KAGAKU-KISO TO OUYOU-(Metalorganic Chemistry-Fundamental and Application-)” authored by Akio Yamamoto, published by Shokabo Publishing Co., Ltd. in 1982.

Specific examples of the ligands include preferably halogen ligands (preferably chlorine ligands), aromatic carboxycyclic ligands (e.g., cyclopentadienyl anions, benzene anions, or naphthyl anions and the like), nitrogen-containing heterocyclic ligands (e.g., phenylpyridine, benzoquinoline, quinolinol, bipyridyl, or phenanthroline and the like), diketone ligands (e.g., acetylacetone and the like), carboxylic acid ligands (e.g., acetic acid ligands and the like), alcoholate ligands (e.g., phenolate ligands and the like), carbon monoxide ligands, isonitryl ligands, and cyano ligand, and more preferably nitrogen-containing heterocyclic ligands.

The above-described complexes may be either a complex containing one transition metal atom in the compound, or a so-called polynuclear complex containing two or more transition metal atoms wherein different metal atoms may be contained at the same time.

Among these, specific examples of the luminescent dopants include phosphorescence luminescent compounds described in patent documents such as U.S. Pat. No. 6,303,238B1, U.S. Pat. No. 6,097,147, WO00/57676, WO00/70655, WO01/08230, WO01/39234A2, WO01/41512A1, WO02/02714A2, WO02/15645A1, WO02/44189A1, JP-A No. 2001-247859, Japanese Patent Application No. 2000-33561, JP-A Nos. 2002-117978, 2002-225352, and 2002-235076, Japanese Patent Application No. 2001-239281, JP-A No. 2002-170684, EP1211257, JP-A Nos. 2002-226495, 2002-234894, 2001-247859, 2001-298470, 2002-173674, 2002-203678, 2002-203679, and 2004-357791, Japanese Patent Application Nos. 2005-75340 and 2005-75341, etc. Among these, more preferable examples of the luminescent dopants include Ir complexes, Pt complexes, Cu complexes, Re complexes, W complexes, Rh complexes, Ru complexes, Pd complexes, Os complexes, Eu complexes, Tb complexes, Gd complexes, Dy complexes, and Ce complexes; particularly preferable are Ir complexes, Pt complexes, and Re complexes; and among these, Ir complexes, Pt complexes, and Re complexes each containing at least one coordination mode of metal-carbon bonds, metal-nitrogen bonds, metal-oxygen bonds, and metal-sulfur bonds are preferred.

<<Fluorescence Luminescent Dopant>>

Examples of the above-described fluorescence luminescent dopants generally include benzoxazole, benzoimidazole, benzothiazole, styrylbenzene, polyphenyl, diphenylbutadiene, tetraphenylbutadiene, naphthalimide, coumarin, pyran, perinone, oxadiazole, aldazine, pyralidine, cyclopentadiene, bis-styrylanthracene, quinacridone, pyrrolopyridine, thiadiazolopyridine, cyclopentadiene, styrylamine, aromatic dimethylidene compounds, condensed polyaromatic compounds (anthracene, phenanthroline, pyrene, perylene, rubrene, pentacene and the like), a variety of metal complexes represented by metal complexes of 8-quinolynol, pyromethene complexes or rare-earth complexes, polymer compounds such as polythiophene, polyphenylene or polyphenylenevinylene, organic silanes, and derivatives thereof.

Among these, specific examples of the luminescent dopants include the following compounds, but it should be noted that the present invention is not limited thereto.

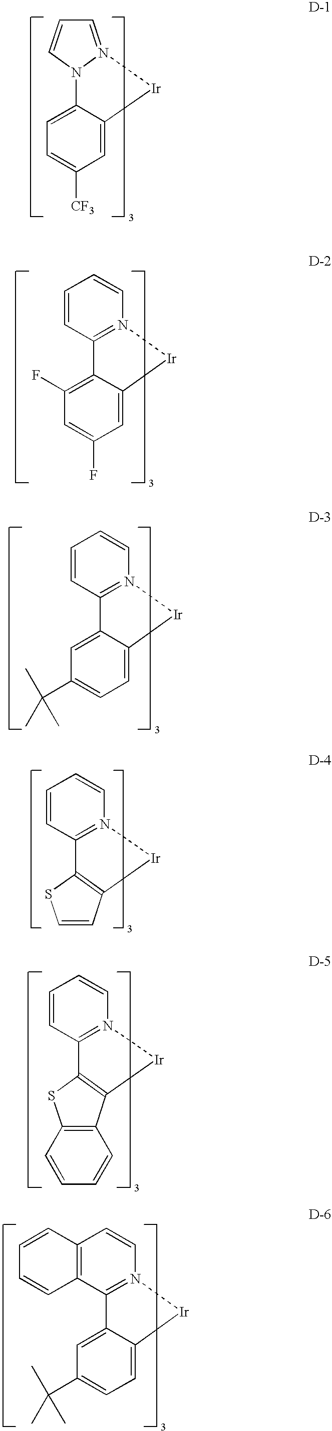

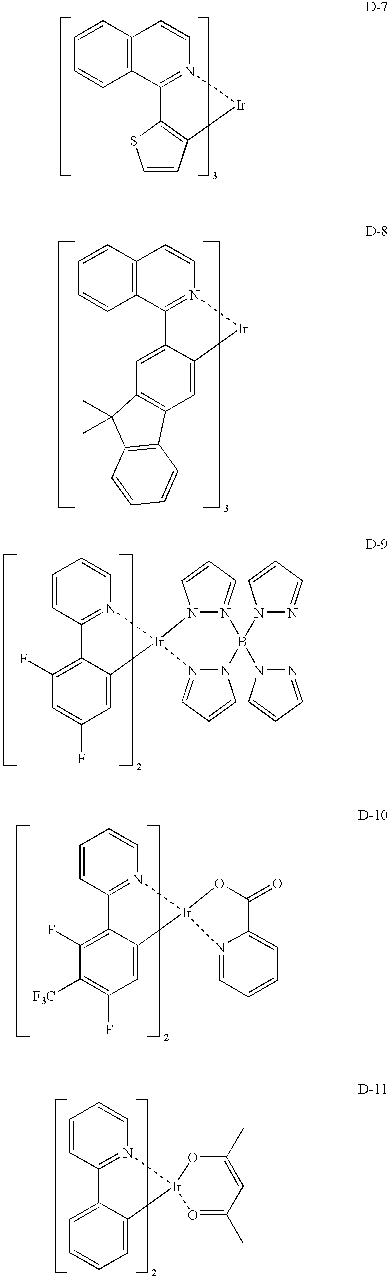

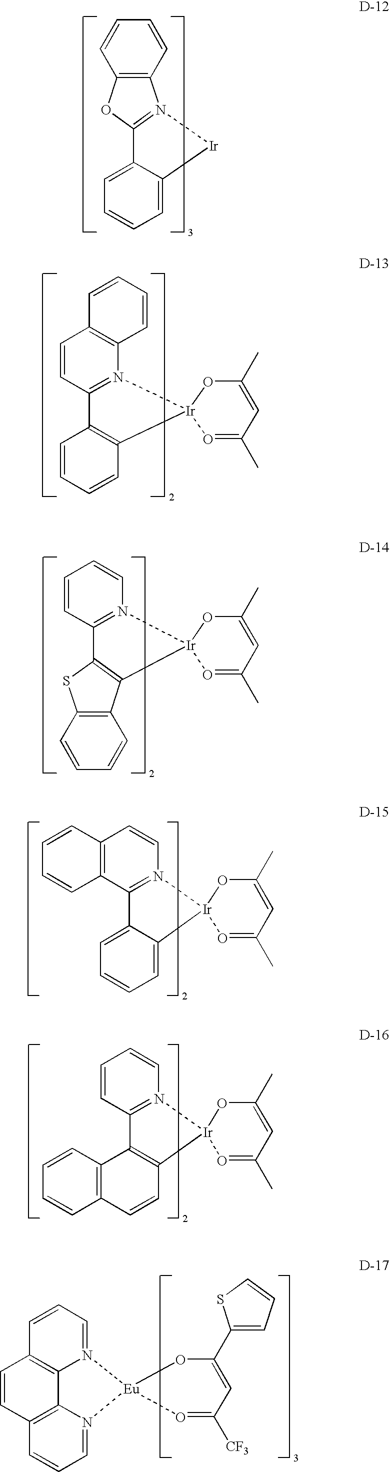

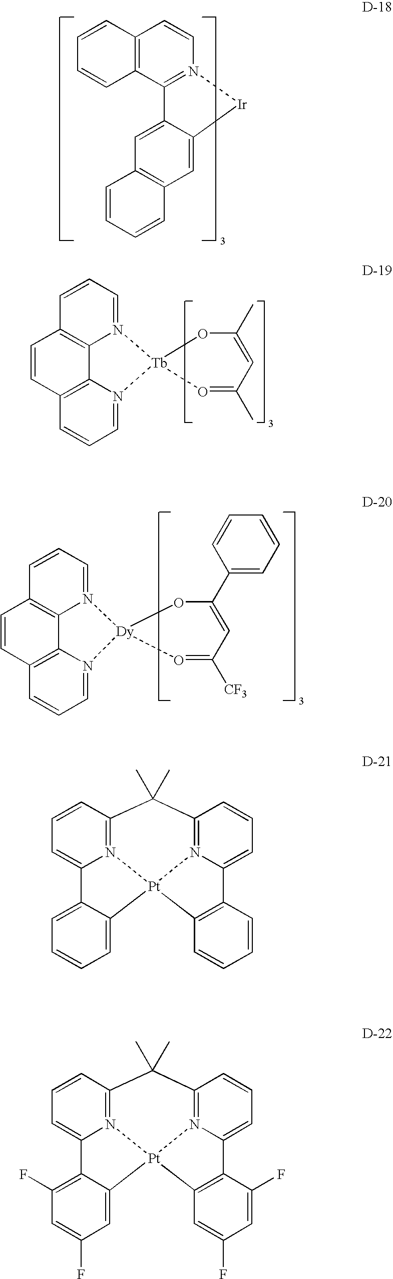

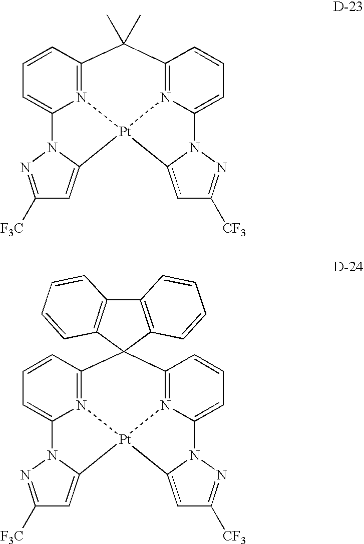

Among the above-described compounds, as the luminescent dopants to be used according to the present invention, D-2, D-3, D-4, D-5, D-6, D-7, D-8, D-9, D-10, D-11, D-12, D-13, D-14, D-15, D-16, D-21, D-22, D-23, or D-24 is preferable, D-2, D-3, D-4, D-5, D-6, D-7, D-8, D-12, D-14, D-15, D-16, D-21, D-22, D-23, and D-24 is more preferable, and D-21, D-22, D-23, or D-24 is further preferable in view of luminescent efficiency, and durability.

The luminescent dopant in a light-emitting layer is contained in an amount of 0.1% by mass to 30% by mass with respect to the total mass of the compounds generally forming the light-emitting layer, but it is preferably contained in an amount of 1% by mass to 15% by mass, and more preferably in an amount of 2% by mass to 12% by mass in view of durability and luminescent durability.

Although a thickness of the light-emitting layer is not particularly limited, 1 nm to 500 nm is usually preferred, and within this range, 5 nm to 200 nm is more preferable, and 5 nm to 100 nm is further preferred in view of luminescent efficiency.

### (Host Material)

The host material to be employed in the present invention may be the host materials already known. The host material of the first light-emitting layer of the present invention preferably has a glass transition temperature within a temperature range lower than the heating temperature for denaturing. The host material of the second light-emitting layer of the present invention preferably has a glass transition temperature within a temperature range higher than the heating temperature for denaturing.

The host material to be employed in each light-emitting layer of the present invention may be formed by a mixture of plural different materials. Preferably, there may be employed a positive hole transporting host material having a satisfactory positive hole transporting property (also represented as a positive hole-transporting host) and an electron transporting host material having a satisfactory electron transporting property (also represented as an electron-transporting host).

<<Positive Hole Transporting Host>>

The positive hole transporting host used for the organic layer of the present invention preferably has an ionization potential Ip of 5.1 eV to 6.3 eV, more preferably has an ionization potential of 5.4 eV to 6.1 eV, and further preferably has an ionization potential of 5.6 eV to 5.8 eV in view of improvements in durability and decrease in driving voltage. Furthermore, it preferably has an electron affinity Ea of 1.2 eV to 3.1 eV, more preferably of 1.4 eV to 3.0 eV, and further preferably of 1.8 eV to 2.8 eV in view of improvements in durability and decrease in driving voltage.

Specific examples of such positive hole transporting hosts as mentioned above include pyrrole, carbazole, triazole, oxazole, oxadiazole, pyrazole, imidazole, polyarylalkane, pyrazoline, pyrazolone, phenylenediamine, arylamine, amino-substituted chalcone, styrylanthracene, fluorenone, hydrazone, stilbene, silazane, aromatic tertiary amine compounds, styrylamine compounds, aromatic dimethylidine compounds, porphyrin compounds, polysilane compounds, poly(N-vinylcarbazole), aniline copolymers, electroconductive high-molecular oligomers such as thiophene oligomers, polythiophenes and the like, organic silanes, carbon films, derivatives thereof, and the like.

Among these, carbazole derivatives, aromatic tertiary amine compounds, and thiophene derivatives are preferable, and particularly, compounds containing, a plurality of carbazole skeletons and/or aromatic tertiary amine skeletons in a molecule are preferred.

As specific examples of the positive hole transporting hosts described above, the following compounds may be listed, but the present invention is not limited thereto.

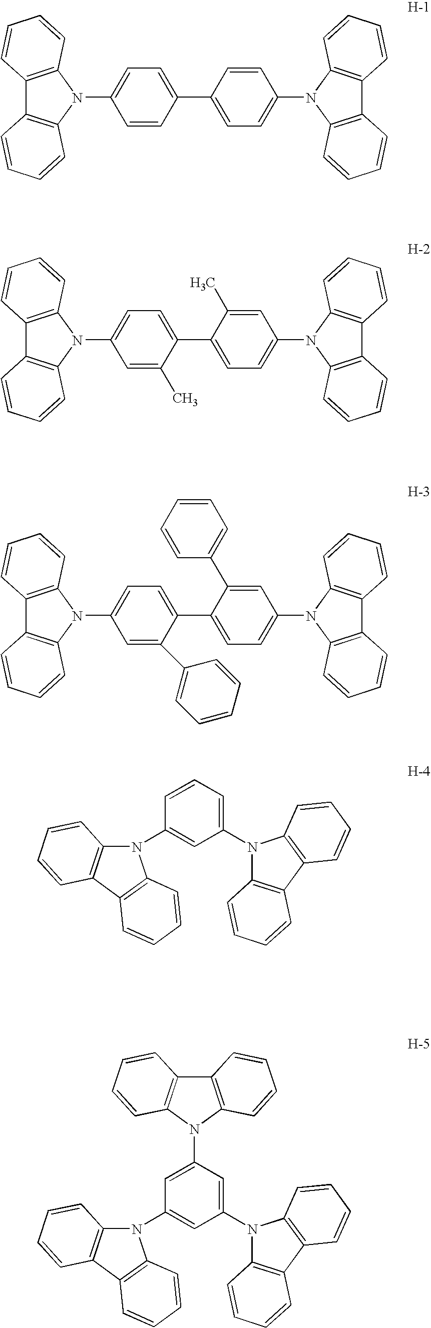

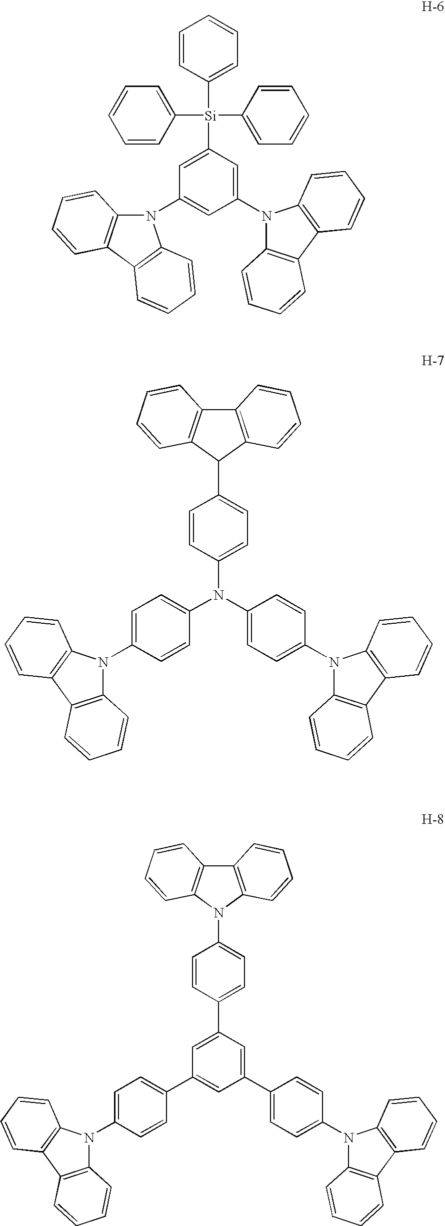

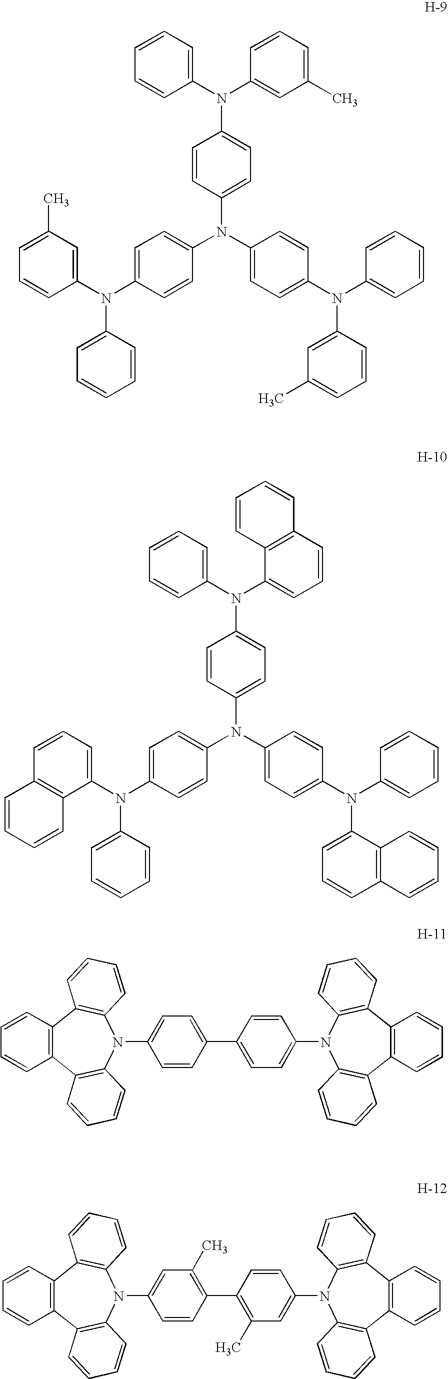

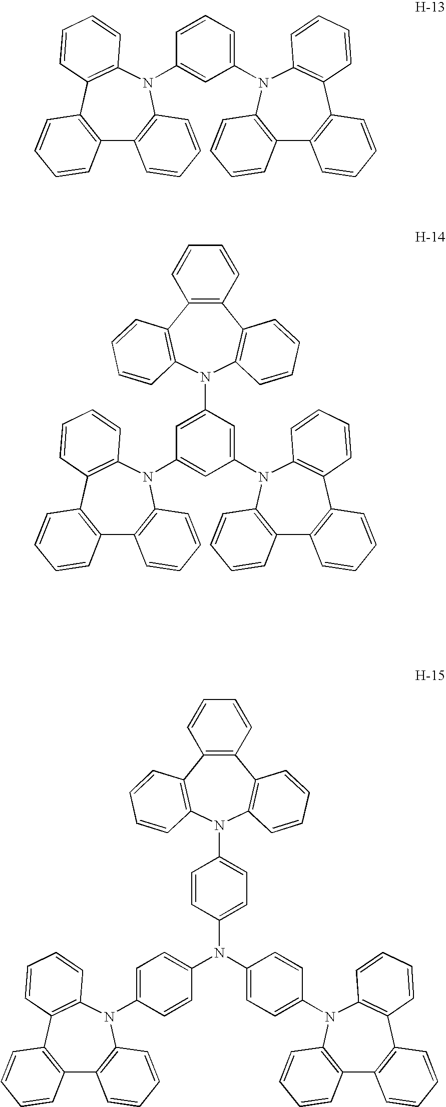

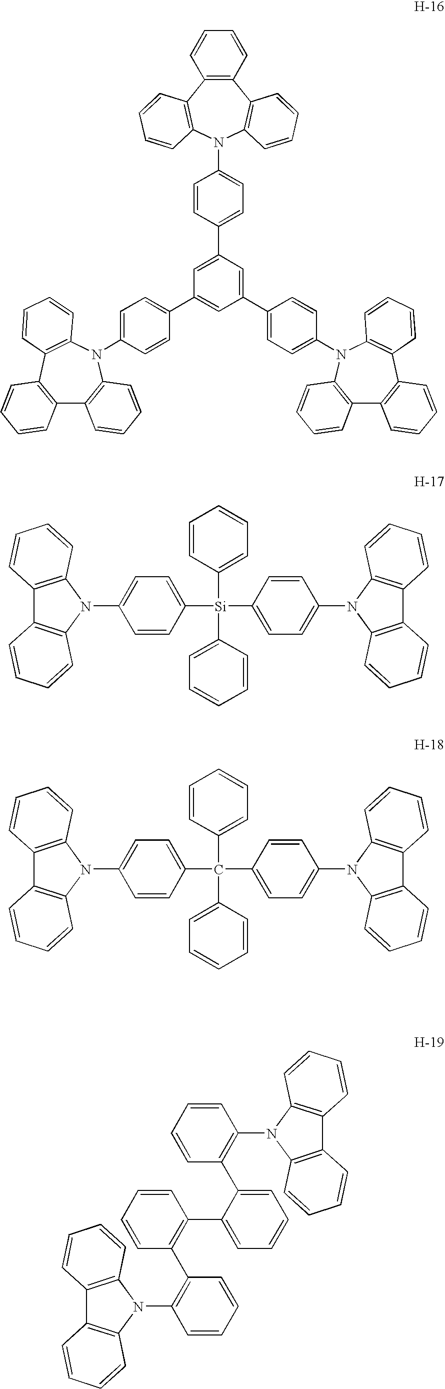

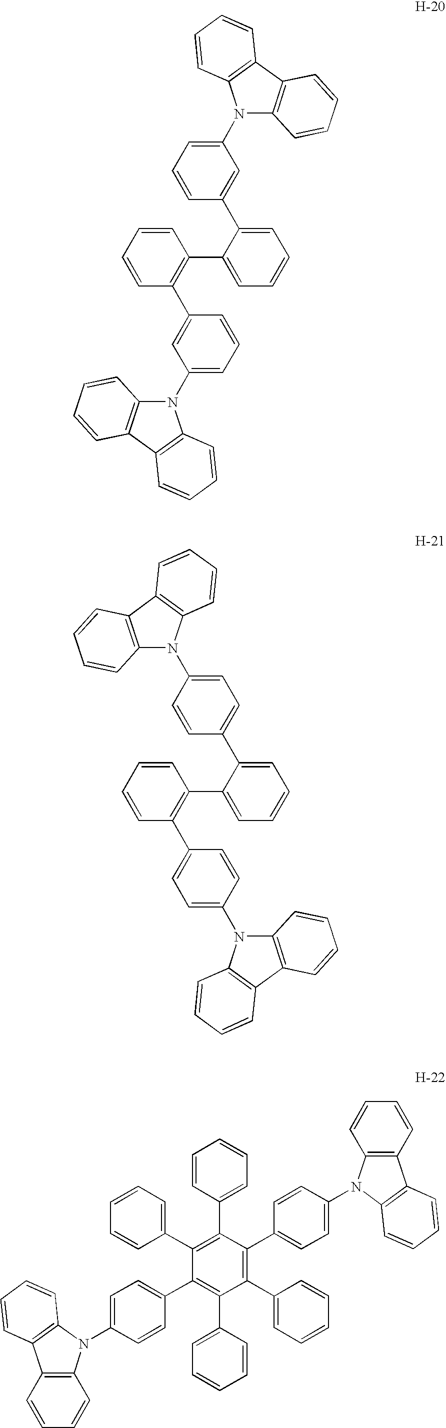

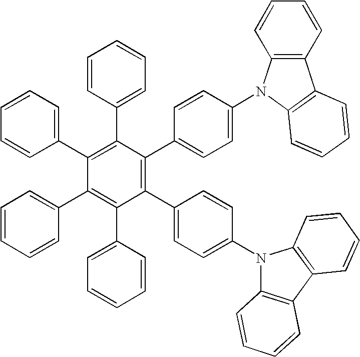

<<Electron Transporting Host>>

As the electron transporting host used according to the present invention, it is preferred that an electron affinity Ea of the host is 2.5 eV to 3.5 eV, more preferably 2.6 eV to 3.2 eV, and further preferably 2.8 eV to 3.1 eV in view of improvements in durability and decrease in driving voltage. Furthermore, it is preferred that an ionization potential Ip of the host is 5.7 eV to 7.5 eV, more preferably 5.8 eV to 7.0 eV, and further preferably 5.9 eV to 6.5 eV in view of improvements in durability and decrease in driving voltage.

Specific examples of such electron transporting hosts as mentioned above include pyridine, pyrimidine, triazine, imidazole, pyrazole, triazole, oxazole, oxadiazole, fluorenone, anthraquinonedimethane, anthrone, diphenylquinone, thiopyrandioxide, carbodiimide, fluorenylidenemethane, distyrylpyradine, fluorine-substituted aromatic compounds, heterocyclic tetracarboxylic anhydrides such as naphthaleneperylene and the like, phthalocyanine, derivatives thereof (which may form a condensed ring with another ring), and a variety of metal complexes represented by metal complexes of 8-quinolynol derivatives, metal phthalocyanine, and metal complexes having benzoxazole or benzothiazole as the ligand.

Preferable electron transporting hosts are metal complexes, azole derivatives (benzimidazole derivatives, imidazopyridine derivatives and the like), and azine derivatives (pyridine derivatives, pyrimidine derivatives, triazine derivatives and the like). Among these, metal complexes are preferred according to the present invention in view of durability. As the metal complex compound, a metal complex containing a ligand having at least one nitrogen atom, oxygen atom, or sulfur atom to be coordinated with the metal is more preferable.

Although a metal ion in the metal complex is not particularly limited, a beryllium ion, a magnesium ion, an aluminum ion, a gallium ion, a zinc ion, an indium ion, a tin ion, a platinum ion, or a palladium ion is preferred; more preferable is a beryllium ion, an aluminum ion, a gallium ion, a zinc ion, a platinum ion, or a palladium ion; and further preferable is an aluminum ion, a zinc ion, or a palladium ion.

Although there are a variety of well-known ligands to be contained in the above-described metal complexes, examples thereof include ligands described in “Photochemistry and Photophysics of Coordination Compounds” authored by H. Yersin, published by Springer-Verlag Company in 1987; “YUHKI KINZOKU KAGAKU-KISO TO OUYOU-(Metalorganic Chemistry-Fundamental and Application-)” authored by Akio Yamamoto, published by Shokabo Publishing Co., Ltd. in 1982, and the like.

The ligands are preferably nitrogen-containing heterocyclic ligands (having preferably 1 to 30 carbon atoms, more preferably 2 to 20 carbon atoms, and particularly preferably 3 to 15 carbon atoms); and they may be a unidentate ligand or a bi- or higher-dentate ligand. Preferable are bi- to hexa-dentate ligands, and mixed ligands of bi- to hexa- dentate ligands with a unidentate ligand are also preferable.

Examples of the ligands include azine ligands (e.g. pyridine ligands, bipyridyl ligands, terpyridine ligands and the like); hydroxyphenylazole ligands (e.g. hydroxyphenylbenzimidazole ligands, hydroxyphenylbenzoxazole ligands, hydroxyphenylimidazole ligands, hydroxyphenylimidazopyridine ligands and the like); alkoxy ligands (those having preferably 1 to 30 carbon atoms, more preferably 1 to 20 carbon atoms, and particularly preferably 1 to 10 carbon atoms, examples of which include methoxy, ethoxy, butoxy, 2-ethylhexyloxy and the like); aryloxy ligands (those having preferably 6 to 30 carbon atoms, more preferably 6 to 20 carbon atoms, and particularly preferably 6 to 12 carbon atoms, examples of which include phenyloxy, 1-naphthyloxy, 2-naphthyloxy, 2,4,6-trimethylphenyloxy, 4-biphenyloxy and the like); heteroaryloxy ligands (those having preferably 1 to 30 carbon atoms, more preferably 1 to 20 carbon atoms, and particularly preferably 1 to 12 carbon atoms, examples of which include pyridyloxy, pyrazyloxy, pyrimidyloxy, quinolyloxy and the like); alkylthio ligands (those having preferably 1 to 30 carbon atoms, more preferably 1 to 20 carbon atoms, and particularly preferably 1 to 12 carbon atoms, examples of which include methylthio, ethylthio and the like); arylthio ligands (those having preferably 6 to 30 carbon atoms, more preferably 6 to 20 carbon atoms, and particularly preferably 6 to 12 carbon atoms, examples of which include phenylthio and the like); heteroarylthio ligands (those having preferably 1 to 30 carbon atoms, more preferably 1 to 20 carbon atoms, and particularly preferably 1 to 12 carbon atoms, examples of which include pyridylthio, 2-benzimidazolylthio, benzooxazolylthio, 2-benzothiazolylthio and the like); siloxy ligands (those having preferably 1 to 30 carbon atoms, more preferably 3 to 25 carbon atoms, and particularly preferably 6 to 20 carbon atoms, examples of which include a triphenylsiloxy group, a triethoxysiloxy group, a triisopropylsiloxy group and the like); aromatic hydrocarbon anion ligands (those having preferably 6 to 30 carbon atoms, more preferably 6 to 25 carbon atoms, and particularly preferably 6 to 20 carbon atoms, examples of which include a phenyl anion, a naphthyl anion, an anthranyl anion and the like anion); aromatic heterocyclic anion ligands (those having preferably 1 to 30 carbon atoms, more preferably 2 to 25 carbon atoms, and particularly preferably 2 to 20 carbon atoms, examples of which include a pyrrole anion, a pyrazole anion, a triazole anion, an oxazole anion, a benzoxazole anion, a thiazole anion, a benzothiazole anion, a thiophene anion, a benzothiophene anion and the like); indolenine anion ligands and the like. Among these, nitrogen-containing heterocyclic ligands, aryloxy ligands, heteroaryloxy groups, aromatic hydrocarbon anion ligands, aromatic heterocyclic anion ligands or siloxy ligands are preferable, and nitrogen-containing heterocyclic ligands, aryloxy ligands, siloxy ligands, aromatic hydrocarbon anion ligands, or aromatic heterocyclic anion ligands are more preferable.

Examples of the metal complex electron transporting hosts include compounds described, for example, in Japanese Patent Application Laid-Open Nos. 2002-235076, 2004-214179, 2004-221062, 2004-221065, 2004-221068, 2004-327313 and the like.

Specific examples of these electron transporting hosts include the following materials, but it should be noted that the present invention is not limited thereto.

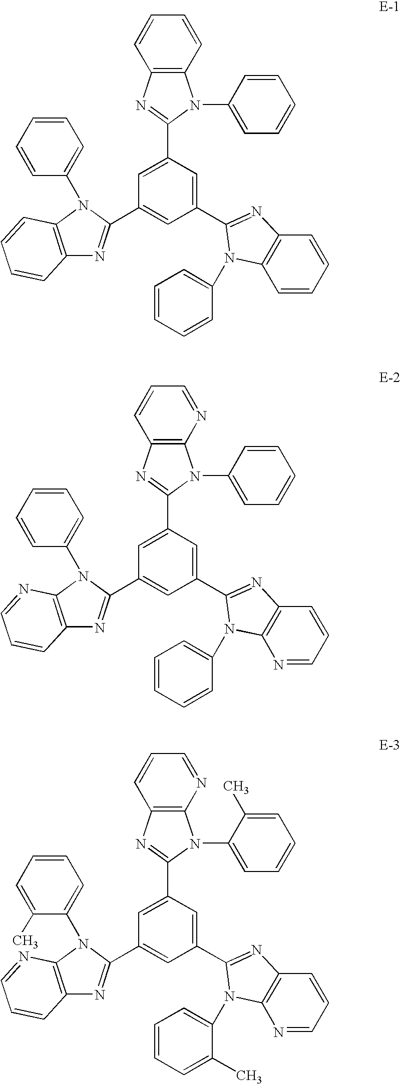

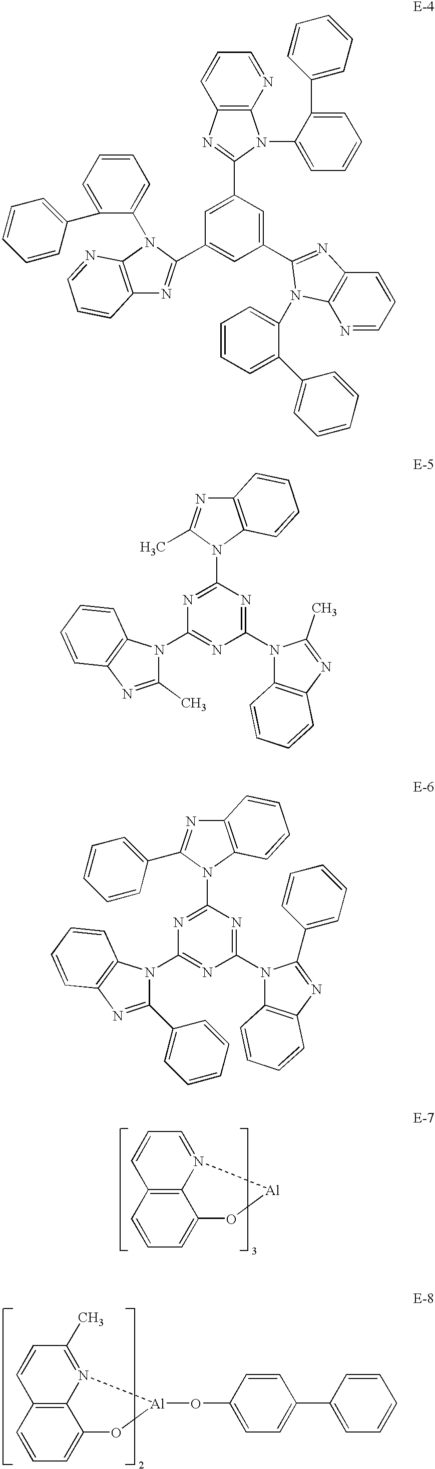

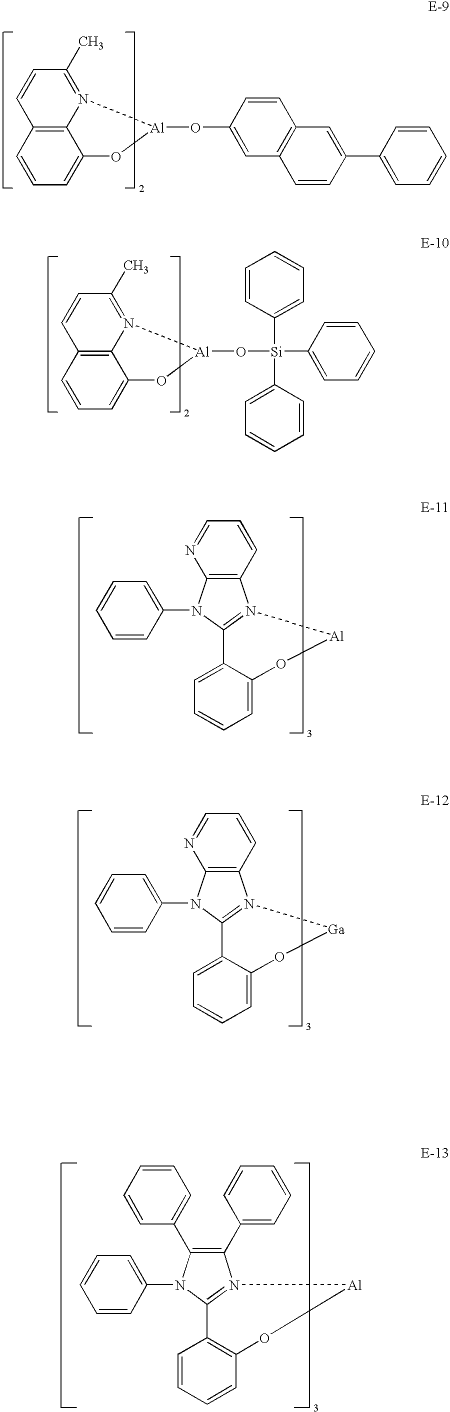

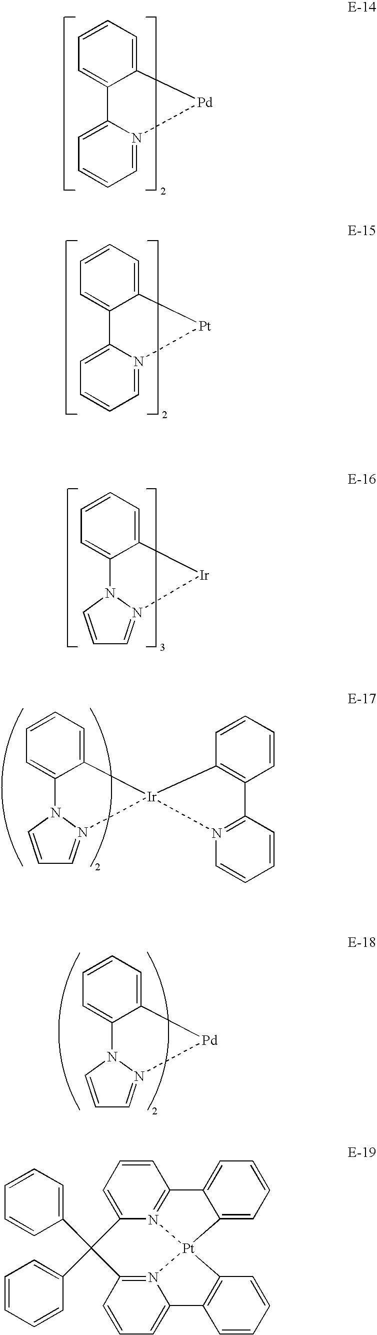

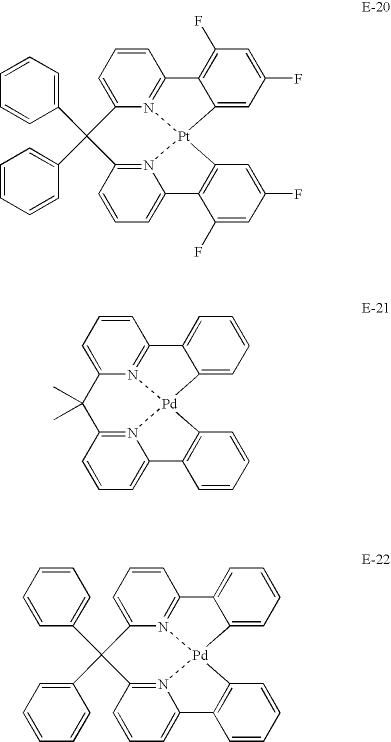

As the electron transportation hosts, E-1 to E-6, E-8, E-9, E-10, E-21, or E-22 is preferred, E-3, E-4, E-6, E-8, E-9, E-10, E-21, or E-22 is more preferred, and E-3, E-4, E-21, or E-22 is further preferred.

Compounds preferably employed as the host material for the first light-emitting layer and as the host material for the second light-emitting layer of the present invention, and glass transition temperatures thereof, will be shown below.

The glass transition temperature in the present invention is a temperature measured by a DSC (differential scanning calorimetry) method.

### Host material having low glass transition temperature

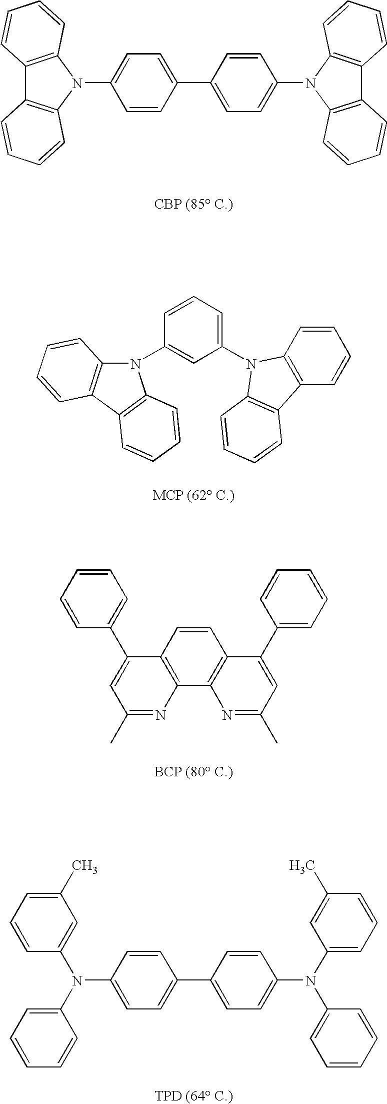

### Host material having high glass transition temperature

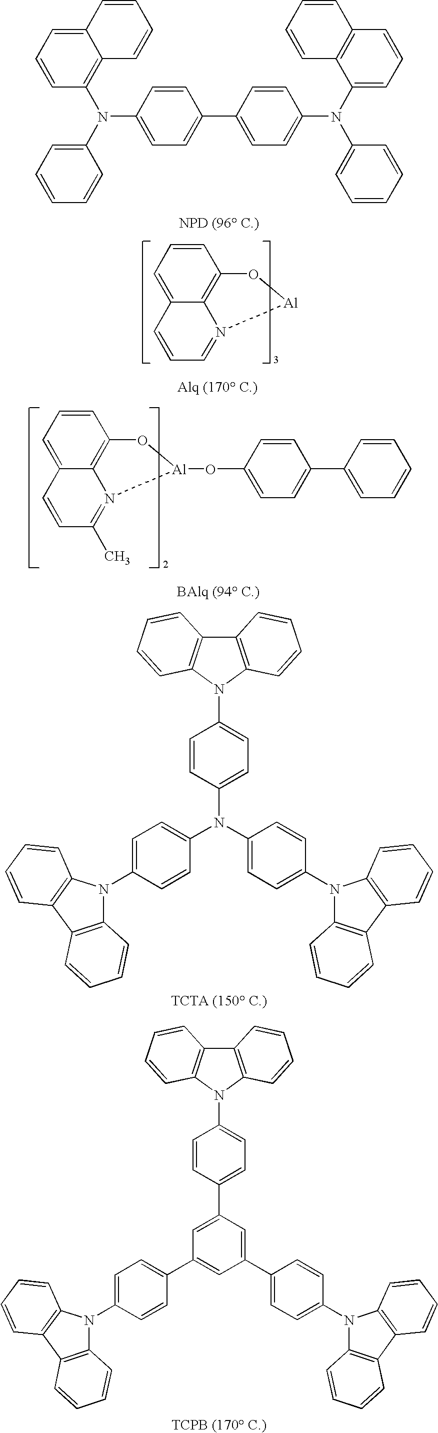

The host material of the first light-emitting layer and the host material of the second light-emitting layer may be used in combination, among the host materials described above, according to the color of light emission and the temperature of heating process.

In the light-emitting layer of the present invention, it is preferred that when a phosphorescence luminescent dopant is used as the luminescent dopant, the lowest triplet excitation energy T1(D) in the phosphorescence luminescent dopant and the minimum value among the lowest triplet excitation energies T1(H) min in the plural host compounds satisfy the relationship of T1(H) min>T1(D) in view of color purity, luminescent efficiency, and driving durability.

Although a content of the host compounds according to the present invention is not particularly limited, it is preferably 15% by mass to 85% by mass with respect to the total mass of the compounds forming the light-emitting layer in view of luminescence efficiency and driving voltage.

A carrier mobility in the light-emitting layer is generally from 10⁻⁷ cm².V⁻¹.s⁻¹ to 10⁻¹ cm².V⁻¹.s⁻¹, and within this range, it is preferably from 10⁻⁶ cm².V⁻¹.s⁻¹ to 10⁻¹ cm².V⁻¹.s⁻¹, further preferably, from 10⁻⁵ cm².V⁻¹.s⁻¹ to 10⁻¹ cm².V⁻¹.s⁻¹, and particularly preferably, from 10⁻⁴ cm².V⁻¹.s⁻¹ to 10⁻¹ cm².V⁻¹.s⁻¹ in view of luminescence efficiency.

It is preferred that the carrier mobility of the light-emitting layer is lower than that of the carrier transportation layer, which will be mentioned herein below, in view of luminescence efficiency and driving durability.

The carrier mobility is measured in accordance with the “Time of Flight” method, and the resulting value is determined to be the carrier mobility.

(Positive Hole-Injection Layer and Positive Hole-Transport Layer)

The positive hole-injection layer and positive hole-transport layer correspond to layers functioning to receive positive holes from an anode or from an anode side and to transport the positive holes to a cathode side.

The positive hole-injection layer and/or positive hole-transport layer of the present invention preferably contain an electron- accepting dopant in view of improvements in decreasing in driving voltage and increasing in driving durability.

As an electron-accepting dopant to be introduced into a positive hole-injection layer or a positive hole-transport layer, either of an inorganic compound or an organic compound may be used as long as the compound has electron accepting property and a function for oxidizing an organic compound. Specifically, inorganic compounds such as halides compounds, for example, ferric chloride, aluminum chloride, gallium chloride, indium chloride, antimony pentachloride and the like, and metal oxides such as vanadium pentaoxide, molybdenum trioxide and the like are preferably used as the inorganic compounds.

In case of the organic compounds, compounds having substituents such as a nitro group, a halogen, a cyano group, or a trifluoromethyl group; quinone compounds, acid anhydride compounds, and fullerenes may be preferably applied.

Specific examples of the organic compounds include hexacyanobutadiene, hexacyanobenzene, tetracyanoethylene, tetracyanoquinodimethane, tetrafluorotetracyanoquinodimethane, p-fluoranil, p-chloranil, p-bromanil, p-benzoquinone, 2,6-dichlorobenzoquinone, 2,5-dichlorobenzoquinone, tetramethylbenzoquinone, 1,2,4,5-tetracyanobenzene, o-dicyanobenzene, p-dicyanobenzene, 1,4-dicyanotetrafluorobenzene, 2,3-dichloro-5,6-dicyanobenzoquinone, p-dinitrobenzene, m-dinitrobenzene, o-dinitrobenzene, p-cyanonitrobenzene, m-cyanonitrobenzene, o-cyanonitrobenzene, 1,4-naphthoquinone, 2,3-dichloronaphthoquinone, 1-nitronaphthalene, 2-nitronaphthalene, 1,3-dinitronaphthalene, 1,5-dinitronaphthalene, 9-cyanoanthoracene, 9-nitroanthracene, 9,10-anthraquinone, 1,3,6,8-tetranitrocarbazole, 2,4,7-trinitro-9-fluorenone, 2,3,5,6-tetracyanopyridine, maleic anhydride, phthalic anhydride, fullerene C60, and fullerene C70. Other specific examples include materials described in patent documents such as JP-A Nos. 6-212153, 11-111463, 11-251067, 2000-196140, 2000-286054, 2000-315580, 2001-102175, 2001-160493, 2002-252085, 2002-56985, 2003-157981, 2003-217862, 2003-229278, 2004-342614, 2005-72012, 2005-166637, 2005-209643 and the like.

Among these, hexacyanobutadiene, hexacyanobenzene, tetracyanoethylene, tetracyanoquinodimethane, tetrafluorotetracyanoquinodimethane, p-fluoranil, p-chloranil, p-bromanil, p-benzoquinone, 2,6-dichlorobenzoquinone, 2,5-dichlorobenzoquinone, 1,2,4,5-tetracyanobenzene, 1,4-dicyanotetrafluorobenzene, 2,3-dichloro-5,6-dicyanobenzoquinone, p-dinitrobenzene, m-dinitrobenzene, o-dinitrobenzene, 1,4-naphthoquinone, 2,3-dichloronaphthoquinone, 1,3-dinitronaphthalene, 1,5-dinitronaphthalene, 9,10-anthraquinone, 1,3,6,8-tetranitrocarbazole, 2,4,7-trinitro-9-fluorenone, 2,3,5,6-tetracyanopyridine, or fullerene C60 is preferable. Hexacyanobutadiene, hexacyanobenzene, tetracyanoethylene, tetracyanoquinodimethane, tetrafluorotetracyanoquinodimethane, p-fluoranil, p-chloranil, p-bromanil, 2,6-dichlorobenzoquinone, 2,5-dichlorobenzoquinone, 2,3-dichloronaphthoquinone, 1,2,4,5-tetracyanobenzene, 2,3-dichloro-5,6-dicyanobenzoquinone, or 2,3,5,6-tetracyanopyridine is particularly preferred, and tetrafluorotetracyanoquinodimethane is more particularly preferred.

These electron-accepting dopants may be used alone or in a combination of two or more of them.

Although an applied amount of these electron-accepting dopants depends on the type of material, 0.01% by mass to 50% by mass of a dopant is preferred with respect to a positive hole-transport layer material, 0.05% by mass to 20% by mass is more preferable, and 0.1% by mass to 10% by mass is particularly preferred. When the amount applied is less than 0.01% by mass with respect to the positive hole transportation material, it is not desirable because the advantageous effects of the present invention are insufficient, and when it exceeds 50% by mass, positive hole transportation ability is deteriorated, and thus, this is not preferred.

As a material for the positive hole-injection layer and the positive hole-transport layer, it is preferred to contain specifically pyrrole derivatives, carbazole derivatives, pyrazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted calcon derivatives, styrylanthracene derivatives, fluorenone derivatives, hydrazone derivatives, stilbene derivatives, silazane derivatives, aromatic tertiary amine compounds, styrylamine derivatives, aromatic dimethylidine compounds, porphyrin compounds, organosilane derivatives, carbon or the like.

Although a thickness of the positive hole-injection layer and the positive hole-transport layer is not particularly limited, it is preferred that the thickness is 1 nm to 5 μm, it is more preferably 5 nm to 1 μm, and 10 nm to 500 nm is particularly preferred in view of decrease in driving voltage, improvements in luminescent efficiency, and improvements in durability.

The positive hole-injection layer and the positive hole-transport layer may be composed of a monolayered structure comprising one or two or more of the above-mentioned materials, or a multilayer structure composed of plural layers of a homogeneous composition or heterogeneous compositions.

When the carrier transportation layer adjacent to the light-emitting layer is a positive hole-transport layer, it is preferred that the Ip (HTL) of the positive hole-transport layer is smaller than the Ip (D) of the dopant contained in the light-emitting layer in view of driving durability.

The Ip (HTL) in the positive hole-transport layer may be measured in accordance with the below-mentioned measuring method of Ip.

A carrier mobility in the positive hole-transport layer is usually from 10⁻⁷ cm².V⁻¹.s⁻¹ to 10⁻¹ cm².V⁻¹.s⁻¹; and in this range, from 10⁻⁵ cm².V⁻¹.s⁻¹ to 10⁻¹ cm².V⁻¹.s⁻¹ is preferable; from 10⁻⁴ cm².V⁻¹.s⁻¹ to 10⁻¹ cm².V⁻¹.s⁻¹ is more preferable; and from 10⁻³ cm².V⁻¹.s⁻¹ to 10⁻¹ cm².V⁻¹.s⁻¹ is particularly preferable in view of the luminescent efficiency.

For the carrier mobility, a value measured in accordance with the same method as that of the carrier mobility of the above-described light-emitting layer is adopted.

Moreover, it is preferred that the carrier mobility in the positive hole-transport layer is higher than that in the above-described light-emitting layer in view of driving durability and luminescent efficiency.

(Positive Hole-Blocking Layer)

A positive hole-blocking layer is a layer having a function to prevent the positive holes transported from the anode to the light-emitting layer from passing through to the cathode side. According to the present invention, a positive hole-blocking layer may be provided as an organic compound layer adjacent to the light-emitting layer on the cathode side.

The positive hole-blocking layer is not particularly limited, but specifically, it may contain an aluminum complex such as BAlq, a triazole derivative, a pyrazabol derivative or the like.

It is preferred that a thickness of the positive hole-blocking layer is generally 50 nm or less in order to lower the driving voltage, more preferably it is 1 nm to 50 nm, and further preferably it is 5 nm to 40 nm.

(Anode)

The anode may generally be any material as long as it has a function as an electrode for supplying positive holes to the organic compound layer, and there is no particular limitation as to the shape, the structure, the size or the like. However, it may be suitably selected from among well-known electrode materials according to the application and purpose of luminescent device. As mentioned above, the anode is usually provided as a transparent anode.

Materials for the anode may preferably include, for example, metals, alloys, metal oxides, electroconductive compounds, and mixtures thereof, and those having a work function of 4.0 eV or more are preferred. Specific examples of the anode materials include electroconductive metal oxides such as tin oxides doped with antimony, fluorine or the like (ATO and FTO), tin oxide, zinc oxide, indium oxide, indium tin oxide (ITO), and indium zinc oxide (IZO); metals such as gold, silver, chromium, and nickel; mixtures or laminates of these metals and the electroconductive metal oxides; inorganic electroconductive materials such as copper iodide and copper sulfide; organic electroconductive materials such as polyaniline, polythiophene, and polypyrrole; and laminates of these inorganic or organic electron-conductive materials with ITO. Among these, the electroconductive metal oxides are preferred, and particularly, ITO is preferable in view of productivity, high electroconductivity, transparency and the like.

The anode may be formed on the substrate in accordance with a method which is appropriately selected from among wet methods such as printing methods, coating methods and the like; physical methods such as vacuum deposition methods, sputtering methods, ion plating methods and the like; and chemical methods such as CVD and plasma CVD methods and the like, in consideration of the suitability to a material constituting the anode. For instance, when ITO is selected as a material for the anode, the anode may be formed in accordance with a DC or high-frequency sputtering method, a vacuum deposition method, an ion plating method or the like.

In the organic electroluminescence device of the present invention, a position at which the anode is to be formed is not particularly limited, but it may be suitably selected according to the application and purpose of the luminescent device. The anode may be formed on either the whole surface or a part of the surface on either side of the substrate.

For patterning to form the anode, a chemical etching method such as photolithography, a physical etching method such as etching by laser, a method of vacuum deposition or sputtering through superposing masks, or a lift-off method or a printing method may be applied.

A thickness of the anode may be suitably selected according to the material constituting the anode and is therefore not definitely decided, but it is usually in the range of around 10 nm to 50 μm, and preferably 50 nm to 20 μm.

A value of resistance of the anode is preferably 10³ Ω/□ or less, and 10² Ω/□ or less is more preferable. In the case where the anode is transparent, it may be either transparent and colorless, or transparent and colored. For extracting luminescence from the transparent anode side, it is preferred that a light transmittance of the anode is 60% or higher, and more preferably 70% or higher.

Concerning transparent anodes, there is a detailed description in “TOUMEI DENNKYOKU-MAKU NO SHINTENKAI (Novel Developments in Transparent Electrode Films)” edited by Yutaka Sawada, published by C.M.C. in 1999, the contents of which are incorporated by reference herein. In the case where a plastic substrate having a low heat resistance is applied, it is preferred that ITO or IZO is used to obtain a transparent anode prepared by forming the film at a low temperature of 150° C. or lower.

(Cathode)

The cathode may generally be any material as long as it has a function as an electrode for injecting electrons to the organic compound layer, and there is no particular limitation as to the shape, the structure, the size or the like. However it may be suitably selected from among well-known electrode materials according to the application and purpose of the luminescent device.

Materials constituting the cathode may include, for example, metals, alloys, metal oxides, electroconductive compounds, and mixtures thereof, and materials having a work function of 4.5 eV or less are preferred. Specific examples thereof include alkali metals (e.g., Li, Na, K, Cs or the like), alkaline earth metals (e.g., Mg, Ca or the like), gold, silver, lead, aluminum, sodium-potassium alloys, lithium-aluminum alloys, magnesium-silver alloys, rare earth metals such as indium, and ytterbium, and the like. They may be used alone, but it is preferred that two or more of them are used in combination from the viewpoint of satisfying both stability and electron injectability.

Among these, as the materials for constituting the cathode, alkaline metals or alkaline earth metals are preferred in view of electron injectability, and materials containing aluminum as a major component are preferred in view of excellent preservation stability.

The term “material containing aluminum as a major component” refers to a material constituted by aluminum alone; alloys comprising aluminum and 0.01% by mass to 10% by mass of an alkaline metal or an alkaline earth metal; or the mixtures thereof (e.g., lithium-aluminum alloys, magnesium-aluminum alloys and the like).

Regarding materials for the cathode, they are described in detail in JP-A Nos. 2-15595 and 5-121172, of which are incorporated by reference herein.

A method for forming the cathode is not particularly limited, but it may be formed in accordance with a well-known method.

For instance, the cathode may be formed in accordance with a method which is appropriately selected from among wet methods such as printing methods, coating methods and the like; physical methods such as vacuum deposition methods, sputtering methods, ion plating methods and the like; and chemical methods such as CVD and plasma CVD methods and the like, in consideration of the suitability to a material constituting the cathode. For example, when a metal (or metals) is (are) selected as a material (or materials) for the cathode, one or two or more of them may be applied at the same time or sequentially in accordance with a sputtering method or the like.

For patterning to form the cathode, a chemical etching method such as photolithography, a physical etching method such as etching by laser, a method of vacuum deposition or sputtering through superposing masks, or a lift-off method or a printing method may be applied.

In the present invention, a position at which the cathode is to be formed is not particularly limited, and it may be formed on either the whole or a part of the organic compound layer.

Furthermore, a dielectric material layer made of fluorides, oxides or the like of an alkaline metal or an alkaline earth metal may be inserted in between the cathode and the organic compound layer with a thickness of 0.1 nm to 5 nm. The dielectric layer may be considered to be a kind of electron injection layer. The dielectric material layer may be formed in accordance with, for example, a vacuum deposition method, a sputtering method, an ion-plating method or the like.

A thickness of the cathode may be suitably selected according to materials for constituting the cathode and is therefore not definitely decided, but it is usually in the range of around 10 nm to 5 μm, and preferably 50 nm to 1 μm.

Moreover, the cathode may be transparent or opaque. The transparent cathode may be formed by preparing a material for the cathode with a small thickness of 1 nm to 10 nm, and further laminating a transparent electroconductive material such as ITO or IZO thereon.

(Substrate)

According to the present invention, a substrate may be applied. The substrate to be applied is preferably one which does not scatter or attenuate light emitted from the organic compound layer. Specific examples of materials for the substrate include zirconia-stabilized yttrium (YSZ); inorganic materials such as glass; polyesters such as polyethylene terephthalate, polybutylene phthalate, and polyethylene naphthalate; and organic materials such as polystyrene, polycarbonate, polyethersulfon, polyarylate, polyimide, polycycloolefin, norbornene resin, poly(chlorotrifluoroethylene), and the like.

For instance, when glass is used as the substrate, non-alkali glass is preferably used with respect to the quality of material in order to decrease ions eluted from the glass. In the case of employing soda-lime glass, it is preferred to use glass on which a barrier coat such as silica has been applied. In the case of employing an organic material, it is preferred to use a material excellent in heat resistance, dimension stability, solvent resistance, electrical insulation, and workability.

There is no particular limitation as to the shape, the structure, the size or the like of the substrate, but it may be suitably selected according to the application, purposes and the like of the luminescent device. In general, a plate-like substrate is preferred as the shape of the substrate. A structure of the substrate may be a monolayer structure or a laminated structure. Furthermore, the substrate may be formed from a single member or two or more members.

Although the substrate may be in a transparent and colorless, or a transparent and colored condition, it is preferred that the substrate is transparent and colorless from the viewpoint that the substrate does not scatter or attenuate light emitted from the organic light-emitting layer.

A moisture permeation preventive layer (gas barrier layer) may be provided on the front surface or the back surface of the substrate.

For a material of the moisture permeation preventive layer (gas barrier layer), inorganic substances such as silicon nitride and silicon oxide may be preferably applied. The moisture permeation preventive layer (gas barrier layer) may be formed in accordance with, for example, a high-frequency sputtering method or the like.

In the case of applying a thermoplastic substrate, a hard-coat layer or an under-coat layer may be further provided as needed.

(Protective Layer)

According to the present invention, the whole organic EL device may be protected by a protective layer.

A material contained in the protective layer may be one having a function to prevent penetration of substances such as moisture and oxygen, which accelerate deterioration of the device, into the device.

Specific examples thereof include metals such as In, Sn, Pb, Au, Cu, Ag, Al, Ti, Ni and the like; metal oxides such as MgO, SiO, SiO₂, Al₂O₃, GeO, NiO, CaO, BaO, Fe₂O₃, Y₂O₃, TiO₂ and the like; metal nitrides such as SiNₓ, SiNₓO_{y} and the like; metal fluorides such as MgF₂, LiF, AlF₃, CaF₂ and the like; polyethylene; polypropylene; polymethyl methacrylate; polyimide; polyurea; polytetrafluoroethylene; polychlorotrifluoroethylene; polydichlorodifluoroethylene; a copolymer of chlorotrifluoroethylene and dichlorodifluoroethylene; copolymers obtained by copolymerizing a monomer mixture containing tetrafluoroethylene and at least one comonomer; fluorine-containing copolymers each having a cyclic structure in the copolymerization main chain; water-absorbing materials each having a coefficient of water absorption of 1% or more; moisture permeation preventive substances each having a coefficient of water absorption of 0.1% or less; and the like.

There is no particular limitation as to a method for forming the protective layer. For instance, a vacuum deposition method, a sputtering method, a reactive sputtering method, an MBE (molecular beam epitaxial) method, a cluster ion beam method, an ion plating method, a plasma polymerization method (high-frequency excitation ion plating method), a plasma CVD method, a laser CVD method, a thermal CVD method, a gas source CVD method, a coating method, a printing method, or a transfer method may be applied.

(Producing Method for Organic Electroluminescence Device)

Various organic compound layers constituting the organic electroluminescence device of the present invention may be formed by any known method, such as a dry film forming method, such as evaporation, sputtering or the like, a transfer method, a printing method, a coating method, an ink jet method, a spray method or the like.

The organic electroluminescence device of the present invention, after formation of these organic compound layers, is partially heated in a controlled pattern by the heating means, whereby a heated portion and an unheated portion are patterned in the plane of the device.

### <Pattern>

A pattern formed by the producing method of the present invention is preferably an assembly of pixels constituting a multi-color display, in which each pixel preferably has an equivalent circular diameter of about from 30 μm to 500 μm. Therefore, the heating is executed so as to form a two-dimensional array in which heated portions and unheated portions are arrayed with a pitch of about from 30 μm to 500 μm.

In order to form pixels of a high definition, the heating is preferably executed at a pitch of about from 30 μm to 100 μm, and more preferably at a pitch of about from 30 μm to 50 μm.

### <Heating Temperature>

In the producing method of the present invention, the heating temperature is preferably higher than the glass transition temperature of a host material in at least a light-emitting layer, and is capable of softening or melting the host material, to thereby cause a denaturing thereof. In the case of producing a multi-color device including plural light-emitting layers having different light emission wavelengths from each other, the heating temperature is preferably selected from temperatures higher than the glass transition temperature of a host material in a light-emitting layer and temperatures lower than the glass transition temperature of a host material in other light-emitting layers.

The lower a glass transition temperature of a host material in the light-emitting layer is, the lower a denaturing temperature can be, but there is a risk that a gradual denaturing may occur during storage even in an unheated portion. Also a host material having an excessively high glass transition temperature is undesirable as it requires a high temperature for denaturing, thus detrimentally affecting the functions of other organic layers. Therefore, the selection of the glass transition temperature of the host material and the selection of the heating temperature are important.

In the present invention, the host material to be denatured has a glass transition temperature preferably within a range of 50° C. to 100° C., and the heating temperature in the producing method of the present invention is selected within such a temperature range. More preferably, the host material to be denatured has a glass transition temperature within a range of 60° C. to 90° C.

In the present invention, the light-emitting material that is not to be denatured has a glass transition temperature which is higher than the upper limit temperature above, preferably by at least 10° C., and more preferably by at least 20° C.

### <Heating Means>

Various means may be employed as the heating means in the present invention.

For example, a thermal head method, a laser heating method or a high frequency heating method may be preferably employed, and more preferably, a thermal head method or a laser heating method is employed.

Heating by Thermal Head Method

A known thermal head, such as a thermal head employed in a printer or the like, may be employed for this purpose. In the case where the organic EL device has a structure of <substrate/anode/organic layer/cathode>, the heating by the thermal head may be executed from the side of the substrate or from the side of the cathode. An arbitrary patterning may be achieved by a scanning motion of the thermal head as in an ordinary thermal head printer. However, in the case where the pattern has a fine pitch, the heating is preferably executed from the side of the cathode, in consideration of diffusion of heat.

Heating by Laser Beam Irradiation

A laser beam of an arbitrary wavelength may be used for this purpose, but the energy of the laser beam has to be converted to heat at the side of the organic EL device. In the case of utilizing a near-infrared semiconductor laser (wavelength from 780 to 830 nm), a near-infrared light absorbing layer is provided on the cathode as a photothermal conversion layer. An arbitrary near-infrared absorbing material may be utilized in such a layer, and, for example, a pigment such as carbon black or a phthalocyanine pigment (for example, titanyl phthalocyanine <TiOPc> advantageously having absorption in the near-infrared region), or a dye such as a phthalocyanine dye or a naphthalocyanine dye can be used. The phthalocyanine dye is capable of being vacuum deposited, and may be deposited in succession to the film formation of the organic EL device, thus being advantageous in simplicity of production.

(Sealing)

The whole organic electroluminescence device of the present invention may be sealed with a sealing cap.

Furthermore, a moisture absorbent or an inert liquid may be used to seal a space defined between the sealing cap and the luminescent device. Although the moisture absorbent is not particularly limited. Specific examples thereof include barium oxide, sodium oxide, potassium oxide, calcium oxide, sodium sulfate, calcium sulfate, magnesium sulfate, phosphorus pentoxide, calcium chloride, magnesium chloride, copper chloride, cesium fluoride, niobium fluoride, calcium bromide, vanadium bromide, molecular sieve, zeolite, magnesium oxide and the like. Although the inert liquid is not particularly limited, specific examples thereof include paraffins; liquid paraffins; fluorine-based solvents such as perfluoroalkanes, perfluoroamines, perfluoroethers and the like; chlorine-based solvents; silicone oils; and the like.

In the organic electroluminescence device of the present invention, when a DC (AC components may be contained as needed) voltage (usually 2 volts to 15 volts) or DC is applied across the anode and the cathode, luminescence can be obtained.

For the driving method of the organic electroluminescence device of the present invention, driving methods described in JP-A Nos. 2-148687, 6-301355, 5-29080, 7-134558, 8-234685, and 8-241047; Japanese Patent No. 2784615, U.S. Pat. Nos. 5,828,429 and 6,023,308 are applicable.

(Application of the Organic Electroluminescence Device of the Present Invention)

The organic electroluminescence device of the present invention can be appropriately used for indicating elements, displays, backlights, electronic photographs, illumination light sources, recording light sources, exposure light sources, reading light sources, signages, advertising displays, interior accessories, optical communications and the like.

### EXAMPLES

In the following, examples of the organic electroluminescence device of the present invention will be described, but it should be noted that the present invention is not limited to these examples.

### Example 1

1. Preparation of the Organic EL Device

(Preparation of Organic EL Device 1 According to the Invention)

A 2.5 cm square ITO glass substrate having a 0.5 mm thickness (manufactured by Geomatec Co., Ltd.; surface resistance: 10 Ω/□) was placed in a washing container to apply ultrasonic cleaning in 2-propanol, and then, UV-ozone treatment was applied for 30 minutes. On the transparent anode, the following layers were deposited in accordance with a vacuum deposition method. In the examples of the present invention, a deposition rate was 0.2 nm/second, unless otherwise specified, wherein the deposition rate was measured by the use of a quartz oscillator. The thicknesses of layers described below were also measured by using the quartz oscillator.

—Positive hole-injection layer—

2-TNATA was evaporated at a thickness of 100 nm.

—First light-emitting layer—

NPD (glass transition temperature: 96° C.) and rubrene were co-evaporated in such a manner that rubrene represented 1.0% by mass with respect to NPD. The first light-emitting layer was given a thickness of 20 nm.

—Second light-emitting layer—

MCP (glass transition temperature: 62° C.) and a blue light-emitting material were co-evaporated in such a manner that the blue light-emitting material represented 10% by mass with respect to MCP. The second light-emitting layer was formed with a thickness of 40 nm.

—Electron-transport layer—

Balq was deposited at a thickness of 10 nm.

—Electron injection layer—

Alq was deposited at a thickness of 20 nm.

On the resulting layers, a patterned mask (mask by which the light emitting region becomes 10 mm×10 mm) was disposed, and lithium fluoride was evaporated at a thickness of 1 nm at a deposition rate of 0.1 nm/second. Further, metal aluminum was deposited thereon with a 100 nm thickness to obtain a cathode.

—Heating—

A half side area (5 mm×10 mm) of the light-emitting area was heated by a thermal head at a temperature of 80° C. to denature the second light-emitting layer.

The prepared lamination body was placed in a globe box whose the contents were replaced by argon gas, and it was sealed by the use of a sealing cap made of stainless steel and a UV curable adhesive (trade name: XNR5516HV, manufactured by Nagase-Ciba Co., Ltd.). Thus organic EL device 1 according to the invention was prepared.

Structures of the compounds used in the above-described luminescent devices are shown below.

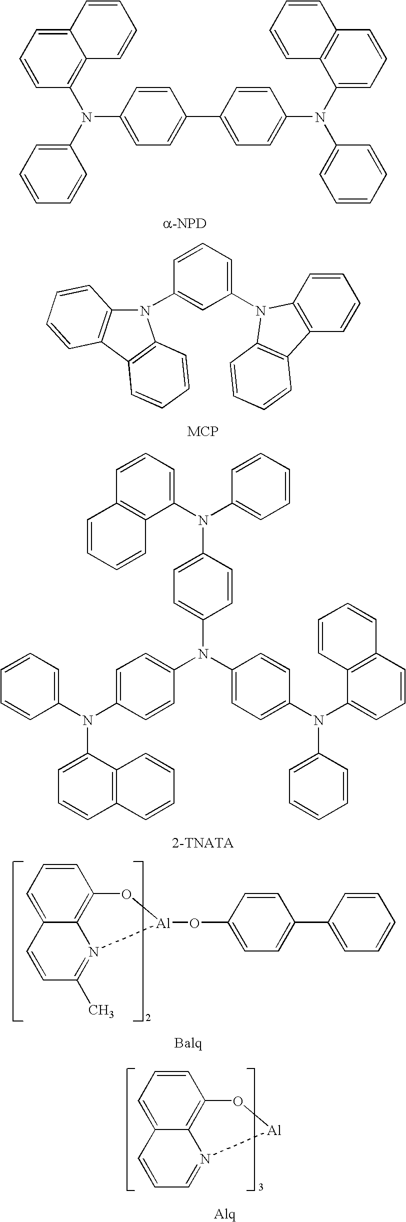

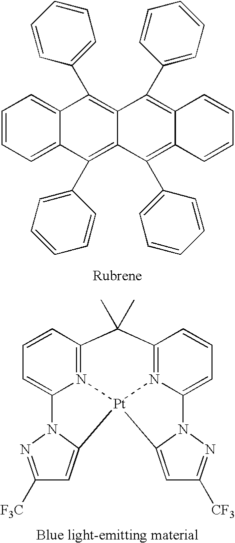

### <Light Emission Test>

The multi-color light-emitting property was tested by applying a DC voltage of 10 V between the ITO (anode) and the aluminum (cathode).

As a result, the unheated portion emitted blue light, and the heated portion emitted yellow light.

### Example 2

1. Preparation of an Organic EL Device 2 According to the Invention

A process was conducted in the same manner as in the organic EL device 1, except that the electron transport layer was eliminated, also a following hole transport layer was provided between the hole injection layer and the first light-emitting layer, and the light-emitting layers were changed as shown below.

Hole transport layer: NPD was evaporated with a thickness of 10 nm.

First light-emitting layer: MCP (glass transition temperature: 62° C.) and a blue light-emitting material were co-evaporated in such a manner that the blue light-emitting material represented 10% by mass with respect to MCP. The first light-emitting layer was formed with a thickness of 40 nm.

Second light-emitting layer: Balq (glass transition temperature: 94° C.) was co-evaporated in such a manner that the rubrene represented 1.0% by mass with respect to Balq. The second light-emitting layer was formed with a thickness of 20 nm.

2. Multi-Color Light Emission Test

As a result of test in the same manner as in Example 1, the unheated portion emitted blue light, while the heated portion emitted yellow light.

### Example 3

1. Preparation of an Organic EL Device 3 of the Present Invention

A process was conducted in the same manner as in the organic EL device 1, except that a following layer for preventing color mixing was provided between the first light-emitting layer and the second light-emitting layer in the organic EL device 1.

Color mixing-preventing layer: NPD (glass transition temperature: 96° C.) was evaporated so as to obtain a thickness of 10 nm.

2. Multi-Color Light Emission Test

As a result of test in the same manner as in Example 1, the unheated portion emitted blue light, while the heated portion emitted yellow light. The colors of the emitted lights were clearer in comparison with those in Example 1.

### Example 4

1. Preparation of an Organic EL Device 3 of the Present Invention

A process was conducted in the same manner as in the organic EL device 2, except that a following layer for preventing color mixing was provided between the first light-emitting layer and the second light-emitting layer in the organic EL device 2.

Color mixing-preventing layer: Balq (glass transition temperature: 94° C.) was evaporated so as to obtain a thickness of 10 nm.

2. Multi-Color Light Emission Test

As a result of test in the same manner as in Example 2, the unheated portion emitted blue light, while the heated portion emitted yellow light. The colors of the emitted lights were clearer in comparison with those in Example 2.

What is claimed is:

1. An organic electroluminescence device comprising an organic layer including at least a light-emitting layer between a pair of electrodes, wherein a light-emitting plane of the organic electroluminescence device comprises at least two light-emitting areas having light emission colors that are different from each other, of which one is a first light-emitting area emitting a light of a first color and another is a second light-emitting area emitting a light of a second color, wherein the second light-emitting area has a composition that is the same as that of the first light-emitting area and is denatured to the second light-emitting area by heating.

2. The organic electroluminescence device according to claim 1, wherein the light-emitting layer includes at least two laminated layers, wherein a first light-emitting layer is a light-emitting layer denatured by the heating, and a second light-emitting layer is a light-emitting layer not denatured by the heating.

3. The organic electroluminescence device according to claim 2, wherein the first light-emitting layer includes a first host material having a glass transition temperature lower than a temperature of the heating, and the second light-emitting layer includes a second host material having a glass transition temperature higher than the temperature of the heating.

4. The organic electroluminescence device according to claim 2, wherein the first light-emitting layer and the second light-emitting layer each independently contain a dopant, and the device further comprises an organic layer substantially free of the dopant between the first light-emitting layer and the second light-emitting layer.

5. The organic electroluminescence device according to claim 2, comprising at least a light reflecting plane at the side of one of the electrodes, wherein the first light-emitting layer and the second light-emitting layer have light emission wavelengths that are different from each other, and the light-emitting layer having the shorter wavelength is positioned between the light-emitting layer having the longer wavelength and the light reflecting plane.

6. A producing method for an organic electroluminescence device comprising at least two light-emitting areas in a light-emitting plane having different wavelengths of light emission, wherein the producing method comprises forming a laminate member, in which a first electrode, an organic layer including at least a light-emitting layer, and a second electrode are laminated on a substrate, and then carrying out denaturing by locally heating at a temperature higher than a glass transition temperature of a host material of the light-emitting layer, to thereby form either one of the light-emitting areas.

7. The producing method for an organic electroluminescence device according to claim 6, wherein the organic electroluminescence device includes a first light-emitting layer containing a host material having a glass transition temperature lower than a temperature of the denaturing and a second light-emitting layer containing a host material having a glass transition temperature higher than the temperature of the denaturing, and only the first light-emitting layer is denatured by the heating.

8. The producing method for an organic electroluminescence device according to claim 6, wherein the heating is executed by a thermal head.

9. The producing method for an organic electroluminescence device according to claim 6, wherein the heating is executed by laser irradiation.
